(19) United States
(12) Patent Application Publication
(10) Pub. No.: US 2013/0204728 A1
(43) Pub. Date: Aug. 8, 2013

(54) Intelligent Meta-Payment System

(71) Applicants: David Aaron Lichterman, Seattle, WA (US); Mathias Joseph Rengert, Chicago, IL (US)

(72) Inventors: David Aaron Lichterman, Seattle, WA (US); Mathias Joseph Rengert, Chicago, IL (US)

(21) Appl. No.: 13/367,773

(22) Filed: Feb. 7, 2012

(51) Int. Cl. G06Q 20/32; G06Q 30/06

(52) U.S. Cl. 705/26.1

(57) ABSTRACT

The present invention relates generally to payment systems and a method of selecting a specific payment method from a plurality of available payment methods. More specifically, the present invention is a system and method of selecting the payment method from a plurality of payment methods that provides the most benefits and/or fewest fees to the purchasing party with respect to the specific purchase. The system and method may take into account location, user-inputted data, data supplied from a merchant, consumer behavior, and may be additionally connected to location data services, electronically stored payment methods and their attributes including rewards and fees. The system may further effect a transaction via communications between a merchant and a consumer via a personal computing device, a programmable magnetic strip, or virtually via the Internet or over telephony.

### FIELD OF THE INVENTION

The present invention relates generally to payment systems and a method of selecting a specific payment method from a plurality of available payment methods. More specifically, the present invention is a system and method of selecting the payment method from a plurality of payment methods that provides the most benefits to the purchasing party with respect to the specific purchase.

### BACKGROUND OF THE INVENTION

Payment systems and methods are an integral part of modern society. Consumer can purchase goods from merchants using a variety of methods including cash, credit cards, bank transfers, an exchange of goods, other financial services, or a combination thereof. There are also numerous ways to complete transactions: in person, over the phone, and through the Internet. Additionally, each transaction may be for a different category of goods or services, such as medical services, travel expenses, retail purchases, etc. Furthermore, a consumer may have methods of payments that involved tiered reward structures, complex fee structures, and other attributes. It is possible for a customer to have a variety of payment options for each purchase.

Each individual payment method may have a particular benefit or drawback depending on the type of transaction and/or the type of goods or services purchased. Some payment methods may provide points, miles, or cash back for a particular type of transaction or a specific type of good. Some payment methods may offer double or triple mileage, points, or cash back if the good or service purchased falls within a designated category. Other payment methods may have rewards which increase with levels of expenditure. Still other payment methods may have fee schedules, some of which can vary based on use. If the purchase of goods or services is a foreign purchase, one particular payment method may offer a better exchange rate and a lower foreign transaction fee than another payment method. Depending on the transaction, a particular payment method may be more advantageous than the other payment methods available to the customer.

When a customer goes to a brick and mortar store or place of service, the customer may decide to purchase an item. The customer may have a variety of payment options. For example, the customer may decide to pay with cash. The customer may also choose to pay with a credit card, of which he may have multiple credit cards to choose from. Depending on the type of transaction, one payment method may be the most beneficial method. For example, if the customer is purchasing fuel for his vehicle, a first credit card may give 5% cash back on gas instead of a second credit card that generically provides 1% cash back on all purchases. In this instance, the customer would likely desire the transaction be completed on the first credit card instead of the second credit card. Completing the transaction on the first card maximizes the customer's benefits.

When a customer purchases an item from an Internet retailer, the customer may be presented with a similar set of payment options. In an Internet setting, there may be additional payment options in addition to credit cards such as direct bank transfers or Internet payment options, for example PAYPAL® and the like. Similar to the brick and mortar situation, a particular payment option may provide more benefits than other payment options.

Customers can have a difficult time selecting the optimal payment method for a given transaction. The customer may have multiple credit cards. The customer may have numerous bank accounts. The customer may belong to various alternative payment groups. Each payment option may have a different interest rate, reward program, transaction fee, and/or exchange fee. Further, each payment option might treat different types or categories of transactions differently, such that the purchase of groceries, for example, might receive a different cash back bonus than the purchase of gasoline. It is likely that customers have a difficult time keeping track of which payment method is optimal for each purchase they make. If the customer cannot readily recognize which payment method in a given scenario, the customer may lose out on additional rewards points, cash back bonus amounts, or may pay more in fees.

### SUMMARY OF THE INVENTION

It is therefore an objective of the present invention to provide a simple, streamlined single-payment system that automatically determines the optimal payment method for the customer's transaction from a plurality of payment options.

An illustrated embodiment of the invention provides for a programmable intelligent meta-payment system. The meta-payment system is operable to determine the optimal payment method based on a series of inputs. The meta-payment system determines the optimal payment method based on the available payment methods, merchant information, and transaction information.

In some embodiments, the user can program the intelligent meta-payment system with multiple available payment methods. These payment methods might include, but are not limited to, any of credit cards, gift cards, debit cards, bank accounts, and Internet payment accounts. Further, the user can program multiple payment methods from within a single category. For example, a user may program the meta-payment system with multiple credit cards.

In some embodiments, the user additionally programs the terms, conditions, features, restrictions, rates, and/or rewards of each individual payment method.

In other embodiments, it is contemplated that the meta-payment system will automatically determine the individual payments' terms, conditions, features, restrictions, rates, and/or rewards by logging into the user's account and gathering the desired information automatically through the Internet

In some embodiments, the meta-payment system can be embodied in a hand-held portable device that facilitates the transaction wirelessly. The hand-held device is operable to determine the location of the device. The location may be determined through GPS, cellular triangulation, Wi-Fi location determination, user input, and/or merchant input. The hand-held device communicates with the merchant's payment system. It is contemplated that the hand-held device communicates wirelessly via a wireless technology such as near field communications (NFC), Wi-Fi, Bluetooth, or any other suitable wireless communication method.

In other embodiments, it is contemplated that the hand-held device can communicate with the merchant payment system via a reprogrammable magnetic strip similar to that of U.S. Pat. No. 7,357,331 to Blossom. The reprogrammable magnetic strip can be dynamically reprogrammed to mimic or clone that of a payment option. The reprogrammable magnetic strip can then be read in a similar fashion to that of a credit card.

In some embodiments, the meta-payment system functions as an intermediary between the merchant and the payment method. It is contemplated that in an Internet retailer setting, the meta-payment system is software that interfaces with the merchant's checkout system.

In further embodiments, it is contemplated that the meta-payment system is capable of comparing non-monetary account rewards to monetary account rewards. For example, some credit cards provide points or frequent flier miles for every dollar charged, while other credit cards simply rebate a certain percentage of all purchases as a cash back bonus. A particular user may value miles more than points and/or more than a cash back bonus. The user can program his preferences into the meta-payment system to indicate his preference of miles, points, or cash back. The user can indicate the preference with a conversion rate between the number of points and/or number of miles to a value of the cash back bonus.

### BRIEF DESCRIPTION OF THE DRAWINGS

FIG. 1 illustrates the overall interaction of the elements of one embodiment of the invention.

FIG. 2 illustrates the process employed to make a payment called the meta-payment method.

FIG. 3 illustrates the configuration process of the device.

FIG. 4 illustrates the payment selection process of the device.

FIG. 5 illustrates the payment determination process of the device.

FIG. 6 illustrates the payment computation process of the device.

FIG. 7 illustrates the payment analysis process of the device.

FIG. 8 illustrates the data retention process of the device.

FIG. 9 illustrates the computation of additional payment variables.

FIG. 10 illustrates the computation of payment characteristics and opportunity costs between multiple payment methods.

FIG. 11 illustrates the computation of tier based payment rewards.

FIG. 12 illustrates the computation of expected payment benefits.

### DETAILED DESCRIPTION OF THE INVENTION

As described above, the present invention is a system for selecting an optimal payment method which provides the greatest benefit to the purchasing party based in a given scenario encompassing a number of variables.

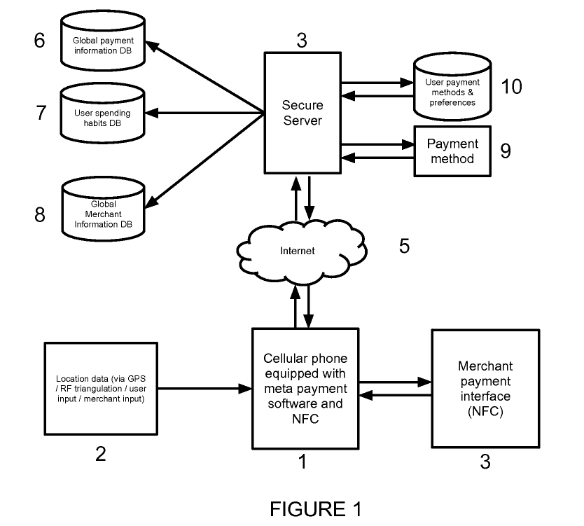

FIG. 1 describes the meta-payment system and the overall interaction of the elements possibly involved in the system. An electronic device 1 such as a personal digital assistant, cellular telephone, smart phone or other personal computing device equipped with meta-payment software and near field communication (NFC) functionality is communicably connected to location services providing location data 2 from a source such as global positioning systems (GPS), RF triangulation, user input, or merchant input and a merchant payment interface 3 also employing near field communication functionality. The electronic device 1 is further communicably connected to one or more servers 4 through the Internet 5. The server 4 is communicably connected to databases or other electronic data containing global payment information 6, user spending habits 7, and global merchant information 8. The server 4 is communicably connected to electronic data containing the purchasing party's plurality of payment methods 9 and the purchasing party's plurality of payment method preferences 10.

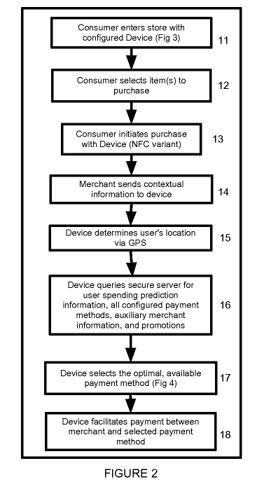

Generally, the meta-payment system operates to select the optimal payment method for a user. In order to operate the meta-payment system, a user, typically the holder of the electronic device 1, will visit a merchant. The user selects the desired items he wishes to purchase while at the merchant. During checkout, the electronic device 1 receives a payment request from the merchant. This request may be received automatically and wirelessly from the merchant's point of sale system. The request my also be entered in manually by the user or the merchant. Upon receipt of the payment request, the meta-payment system analyzes the requested purchase and determines the optimal payment method to complete the transaction. After selecting the optimal payment method, the meta-payment system transmits payment information to the merchant. The details of the meta-payment sub-processes are described below with in FIG. 2 through FIG. 12.

Referring to FIG. 2, the process employed to make a payment utilizing the meta-payment method is illustrated. In the invention, the consumer enters the store 11 with the computing device 1 and selects items available to purchase 12 from the merchant. The consumer then initiates a transaction 13 using the electronic device 1 with NFC. The electronic device 1 communicates with the merchant payment interface 3 wherein the merchant provides contextual information to the computing device 14. The electronic device further determines the location of the consumer 15. The electronic device also queries the secure server 4 to determine user spending prediction information, all configured payment options, any auxiliary merchant information, and any ongoing promotional data 16. Using the contextual information, location information, and other information gathered, the meta-payment method selects the optimal payment method 17 and a payment is facilitated 18 from the purchasing party to the merchant using the selected payment method.

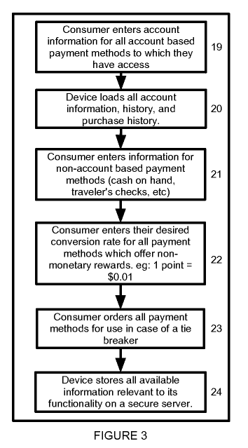

Referring to FIG. 3, the process of the consumer configuring the system 11 is more fully illustrated. The consumer enters account information for all payment methods available to them or a set of those available which they wish to use in the meta-payment system 16. The electronic device 1 loads all the payment account information, account history, and purchase history 20. The consumer further enters payment methods for non-account based payment methods 21 including cash on hand, traveler's checks, coupons and others. Some of the entered payment methods may have rewards associated with them, such as airline miles, points, cash back bonuses, etc. In order to properly equate the various payment methods having different rewards structures, the consumer then enters the desired conversion rate for all non-monetary rewards 22. For example, one hotel, airline, or other reward point is assigned a value or relative worth such as 1 point=$0.01. By entering such information, the meta-payment system is able to properly compare multiple payment methods even though the comparison may involve non-monetary based rewards systems. In the event that the meta system finds two payment methods to be equally optimal for any given purchase, the meta-payment system still needs to ultimately select a payment method for the transaction. To facilitate this, the consumer then sets an order of preference for all payment methods 23 in order to promote one method of payment over others in the case of two or more payment methods being equally optimal. Finally, the meta-payment system stores all programmed information and any information relevant to its functionality on the secure server 24.

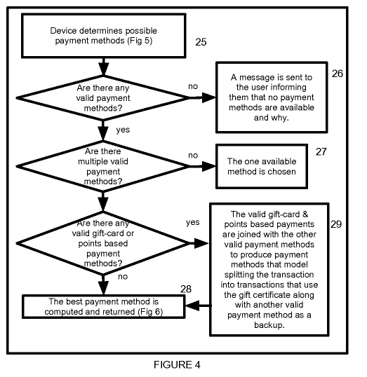

Referring to FIG. 4, the process of system selecting the optimal payment method 17 is more fully illustrated. The system determines the possible payment methods 25 available based on the transaction scenario. For example, a merchant might not accept a certain type of credit card or travelers checks. The meta-payment system will then automatically eliminate the non-accepted payment methods. If no valid payment methods remain, a message is sent to the consumer 26 indicating that no valid payment methods are available for the transaction and why the payment methods are not available. If only one valid payment method is available, the meta-payment system selects this method as being the optimal method for the transaction 27. If there are multiple valid payment methods, the meta-payment system will select the most optimal payment method based on a series of calculations and the user preferences and the optimal payment and returned 28.

It is also possible for the meta-payment system to utilize gift cards or reward points as payment methods. In this scenario, the meta-payment system can split a transaction between a different payment forms. For example, a consumer may have gift card or reward points that can apply towards the purchase of an item. When the meta-payment system is determining the optimal payment method in step 28, the meta-payment system recognizes when applicable gift card balances and/or reward points should be utilized prior to cash or credit payment methods. Thus, the meta-payment system utilizes gift card balances or reward points and treats the calculated optimal cash or credit payment method as a backup if the transaction cost exceeds the value of the gift card or points 29. Most preferably, if the consumer behavior indicates that the consumer is likely to engage in a transaction wherein rewards will be more valuable than in the present scenario, the points are retained and the back-up payment method is the sole payment method.

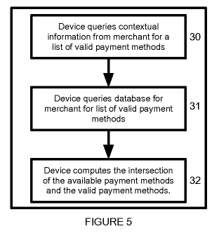

Referring to FIG. 5, the process of the computing system determining the possible payment methods 25 is more fully illustrated. The system communicates with the merchant to obtain contextual information from the merchant including a list of valid payment methods accepted by the merchant 30. The system then queries a database containing a list of user payment methods available 31 and computes which payment methods available to the consumer are valid with the merchant 32.

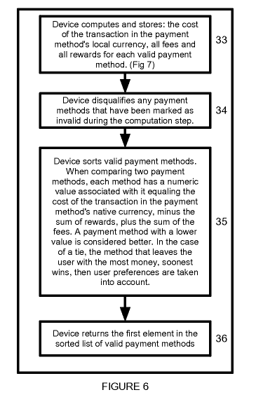

Referring to FIG. 6, the process of computing the optimal payment method 28 is more fully illustrated. Based on the transaction scenario data, the system computes and stores the cost of the transaction in the payment method's local currency, all fees associated with the transaction for each payment method, and all rewards or bonuses for each payment method 28. The system then disqualifies any payment methods 34 that have been previously marked as invalid or unavailable during step 32. The system sorts valid payment methods by the cost of the transaction in the payment method's native currency, minus the sum of rewards plus the sum of the fees, such calculation resulting in a predicted cost. The system then ranks the payment methods from lowest predicted cost to highest predicted cost. In the case that two or more payment methods are equally ranked, the method that leaves the user with the most money, soonest wins. In the case that two or more payment methods are still equally ranked, the user preferences determine which payment method to use. Following the ranking of the payment methods 35, the system returns the first result of the ranking 36, that which is the optimal and most preferable payment method.

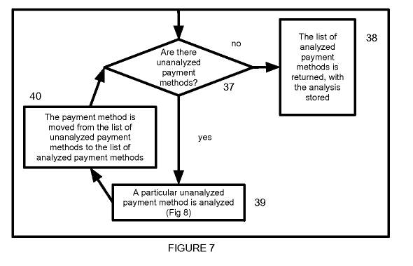

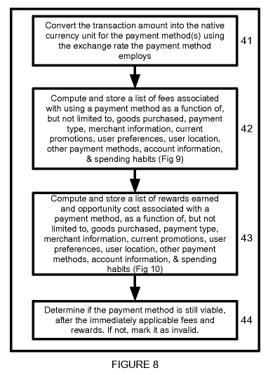

Referring to FIG. 7, the process of the system computing and storing fees 33 is more fully illustrated. The meta-payment system determines if there are unanalyzed payment methods 37 prior to computing the optimal payment method. If there are no unanalyzed payment methods, the list of analyzed payment methods is complete and is returned 38 with the analysis of step 33. If there is an unanalyzed payment method, then that method is properly analyzed by the system 39. The details of the analysis are discussed below with respect to FIG. 8. Once the unanalyzed payment method has been analyzed, the payment method is moved from the list of unanalyzed payment methods to the list of analyzed payment methods 40. This process continues until the group of not analyzed payment methods is null.

Referring to FIG. 8, the process of analyzing a payment method 39 is more fully described. First, the meta-payment system converts the transaction amount into the native currency unit for the various payment methods using the current exchange rate employed by the individual payment method 41. The currency conversion is done to facilitate foreign transactions. However, it is understood that this step may not be necessary for all transactions if the transaction occurs in the same currency as the standard currency of the given payment method. Next, the meta-payment system computes and stores a list of fees associated with using each individual payment method. The list of fees is computed as a function of, but not limited to, goods purchased, payment type, merchant information, current promotions, user preferences, user location, other payment methods, account information, and consumer spending habits 41. Similarly, the meta-payment system computes and stores a list of rewards or bonuses earned and the opportunity costs associated with a given payment method 43. The list of rewards is computed as a function of, but not limited to, goods purchased, payment type, merchant information, current promotions, user preferences, user location, other payment methods, account information, and consumer spending habits. Finally, the meta-payment system determines if any of the payment methods are still viable options, that is the cost plus fees minus rewards can be applied to the payment method and not exceed a credit limit or an account balance given the associated fees and rewards 44. If the payment method is not viable, the payment method is marked as invalid for the given transaction.

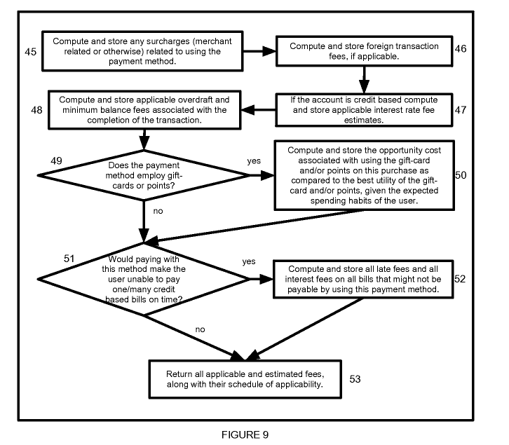

Referring to FIG. 9, the process of computing and storing a list of fees associated with each payment method 42 is described in more detail. To properly compute the fees associated with each payment method, the meta-payment system analyzes different aspects of each payment method for a given transaction. The meta-payment system computes, and stores any surcharges related to using the payment method 45. This computation includes any merchant related fees associated with the given payment method. The meta-payment system computes, and stores foreign transaction fees associated with the payment methods 46. It is noted that not all transactions will incur a foreign transaction fee. In this case, the foreign transaction fee will be recorded as zero. If the payment method is credit based, the meta-payment system computes and stores the applicable interest rate fee estimates 47. The meta-payment system computes and stores any applicable overdraft and minimum balance fees associated with the completion of the transaction 48. In order to complete the list of fees, the meta-payment system also needs to know whether the given transaction can be completed with gift credits and/or reward points 49. If an appropriate payment method for the transaction does employ gift credit or rewards, the meta-payment system computes and stores the opportunity cost associated with using the gift credits and/or rewards points on the transaction as compared to the best utility of the gift credits and/or rewards points based on the consumer's spending habits 50. For each transaction, the meta-payment system also asks whether completing the transaction with a given payment method might make the consumer unable to satisfy financial payments due to various payment methods by exceeding the current or future date-specific amount of monetary funds on hand.51. If the transaction might or will cause the consumer to be unable to make an acceptable bill payment, the meta-payment system then computes and stores all the late fees and any applicable interest fees associated with any bills that might not be payable if the transaction is completed with the given payment method 52. The meta-payment system will compute and store any other transaction fees associated with each payment method for a given transaction. After all fees are computed and stored, the meta-payment system will return all applicable and estimated fees, along with their schedule of applicability 53.

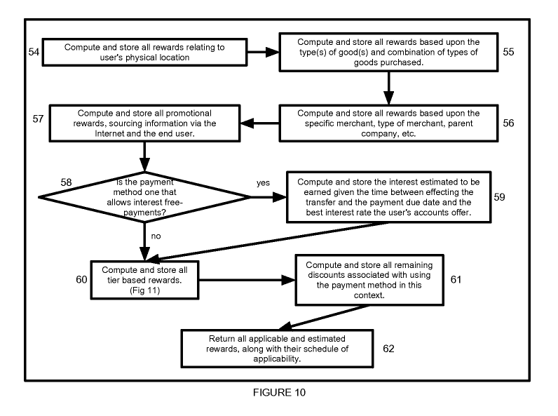

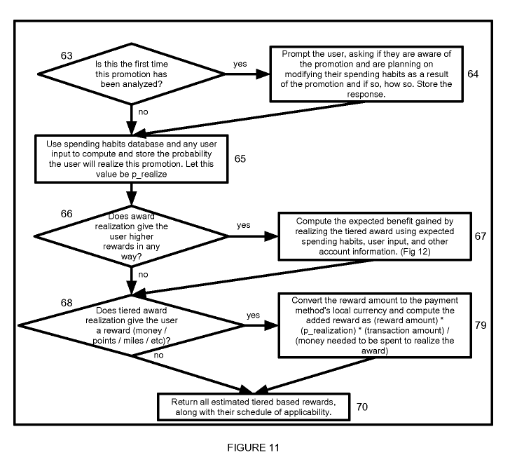

Referring to FIG. 10, the process of computing and storing a list of rewards earned with each payment method and the opportunity cost of those rewards 43 is described in more detail. To properly compute the rewards associated with each payment method, the meta-payment system analyzes different aspects of each payment method for a given transaction. The meta-payment system computes and stores all rewards associated with the consumer's physical location 54. The consumer's location is determined from the location data 2 provided by the consumer's device 1. The meta-payment system computers and stores all rewards based upon the types of goods and the combination of types of goods to be purchased during the transaction 55. The meta-payment system computes and stores all rewards based upon the merchant, and classifications including the type of merchant, the merchant's parent company, or any other details about the merchant 56. The meta-payment system computes and stores all promotional rewards applicable to the transaction located through the internet and/or input by the user 57. After determining the above noted rewards, the meta-payment system then determines if the payment method allows for interest free payments 58. If the payment method does allow for interest free payments, then the meta-payment system computes and stores the interest estimated to be earned given the time between effecting the transfer and the payment due date and the best interest rate the user's accounts offer 59. The meta-payment system determines whether or not delaying payment and keeping the money in an interest bearing account is possible for the given payment method. After the above calculations are complete, the meta-payment system computes and stores all or any tier based rewards 60. The tier based reward calculation is described below with respect to FIG. 11. The meta-payment system computes and stores any remaining discounts associated with using the payment method for the given transaction 61. The meta-payment system then returns all applicable and estimated rewards, along with a schedule of applicability 62.

Referring to FIG. 11, the process of computing and storing tier based rewards 60 is described in more detail. Generally, a tier based reward is a reward that escalates for a given amount. For example, if the user spends $100 a month at a given merchant or on a given type of good, the user might receive 1% cash back, but if the user spends $500, the user might receive 3% cash back. Additionally, a tier based reward might offer the user a reward of intrinsic value. For example, if the user spends $100 on gas, the user might receive $20. The meta-payment system determines if this is the first time this specific tier based promotion has been analyzed 63. If it is the first time, the meta-payment system prompts the user asking if they are aware of the promotion and how, if at all, they are planning on modifying their spending habits as a result of the promotion 64. The meta-payment system then stores the user's response to the question. The meta-payment system uses past spending habits, predicted spending habits, such as those computed by U.S. Pat. No. 6,430,539 to Lazarus et al, which is hereby incorporated by reference, and/or any user input to compute and store the probability that the user will realize a tier of the tiered promotion 65. This probability will be referred to as “p_realize”. Next the meta-payment system determines if the expected spending habits will realize one of the tiers and from that point forward give the user higher rewards 66. If the tier does provide the user with rewards on particular types of purchases, the meta-payment system computes the expected benefit gained by realizing the tiered award using the expected spending habits, user input, and other account information 67. Next, the meta-payment system determines if the expected spending habits will realize a single reward occurrence 68. If there are rewards determined during step 68, the meta-payment system converts the reward amount to the payment method's local currency and computes the added reward as based on the probability of reaching the given tier 69. This calculation will take the form of [(p_realization)*(transaction amount)]/(money needed to be spent to realize the award)]. The meta-payment system then returns all the estimated tiered based rewards along with their schedule of applicability 70.

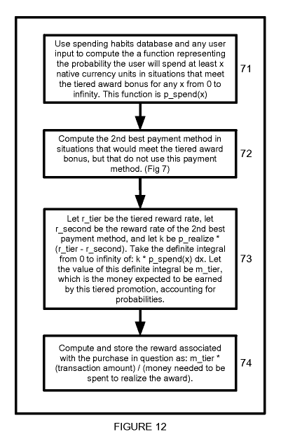

Referring to FIG. 12, the process of computing the expected benefit gained by realizing a tier in a tiered promotion 67 is further detailed. The meta-payment system can continue with the analysis whether or not the tiered promotion has been previously analyzed. Next, the meta-payment system uses the user's predicted spending habits and any user input to compute the probability the user will spend the required amount to meet the tiered promotion 71. The function that represents the probability the user will spend at least a certain amount, x, is referred to as “p_spend(x)” where x is any number greater to or equal to zero. Next, the meta-payment system computes the second best payment method in situations that would meet the tiered award bonus, but that does not use the payment method associated with the tiered award bonus for comparison 72 Let r_tier be the tiered reward rate, let r_second be the reward rate of the second best payment method, and let k be p_realize*(r_tier−r_second). Take the definite integral from 0 to infinity of k*p_spend(x)dx. Let the value of this definite integral be m_tier, which is the money expected to be earned by this tiered promotion, accounting for probabilities 73. Finally, the meta-payment system computes and stores the reward associated with the purchase in question as m_tier*[(transaction amount)/(money needed to be spent to realize the award)] 74.

Using any or all of the factors above, the meta-payment system computes the optimal payment method for a given transaction. The meta-payment system is capable of automatically selecting the optimal payment method. In this case, the device 1 can wirelessly communicate the payment method to the merchant. The meta-payment system is also capable of notifying the user of the optimal payment method, thereby enabling the user to present the optimal payment method to the merchant.

Importantly, in other embodiments of the invention, the near field communications method may be substituted with Wi-Fi, Bluetooth, infrared, or any other wireless or wired communication technique, or any combination of the aforesaid communication techniques.

In other certain embodiments of the invention, a programmable magnetic strip serving as a programmable or proxy credit card holding the meta-payment system may be substituted for the personal computing device 1 having the meta-payment system.

In other embodiments of the invention, an electronic purse accessing the meta-payment system functionality virtually and used for online transactions or transactions over telephony may substituted for the personal computing device 1 having the meta-payment system.

In other embodiments of the invention, the meta-payment system may be accessed virtually and its operations carried out on a remote computer or server while being accessed on a personal computing device, programmable magnetic strip, or via an electronic purse.

While the invention has been illustrated and described in detail in the drawings and foregoing description, such description is to be considered as exemplary and not restrictive in character. It is understood that only exemplary embodiments have been shown and described and that changes and modifications that come within the scope and spirit of the invention are desired to be protected.

We claim:

1. A method of selecting a payment option from a plurality of payment options, comprising:
configuring at least one server with a plurality of user payment options;
configuring a portable device to communicate between the at least one server and a merchant;
configuring the portable device to facilitate payment for a purchase from a merchant;
receiving a purchase payment request from a merchant, the purchase payment request including information about the purchase;
analyzing the information about the purchase;
selecting an optimal payment method from the plurality of payment methods; and
transmitting the optimal payment method to the merchant to complete the purchase.

2. The method of claim 1 wherein the configuring of the at least one server with a plurality of payment options comprises entering account information, account history, or purchase history.

3. The method of claim 2 wherein the configuring of the at least one server comprises entering fee structures, reward structures, currency conversion rates, user preferences, or monetary equivalence values of rewards.

4. The method of claim 1 wherein the information about the purchase comprises information about the merchant including what payment methods are accepted, name of the merchant, location of the merchant, and type of good involved in the purchase.

5. A method of selecting a payment option from a plurality of payment options, comprising:
configuring at least one server with a plurality of user payment options including entering account information, account history, purchase history, fee structures, reward structures, currency conversion rates, user preferences, and monetary equivalence values of rewards;
configuring a portable device to communicate between the at least one server and a merchant, the portable device operable to facilitate payment for a purchase from a merchant;
receiving a purchase payment request from a merchant, the purchase payment request including information about the purchase including information about the merchant including what payment methods are accepted, name of the merchant, location of the merchant, and type of good involved in the purchase;
analyzing the information about the purchase;
selecting an optimal payment method from the plurality of payment methods; and
transmitting the optimal payment method to the merchant to complete the purchase; and
the portable device is configured with a global positioning system.

6. The method of claim 5 wherein the selecting of the optimal payment method comprises eliminating payment methods not accepted by the merchant and selecting a payment method if it is the only payment method available.

7. The method of claim 6 wherein the selecting of the optimal payment method comprises consideration of gift or reward point balances and use of payment methods associated with the gift or reward point balances prior to use of a payment method not associated with them.

8. The method of claim 7 wherein the selecting of the optimal payment method comprises computing the cost of purchase in the payment method's native currency;
subtracting the sum of rewards for a payment method;
adding the sum of fees for a payment method;
ranking the payment methods from lowest cost to highest cost; and
selecting a payment ranked first.

9. The method of claim 7 wherein more than one payment methods are ranked first and user preferences are considered to select one payment methods as the optimal payment method.

10. The method of claim 8 wherein point based rewards are converted to monetary comparison value rewards.

11. The method of claim 10 wherein the selecting of the optimal payment method comprises marking all payment methods as unanalyzed and making a list of unanalyzed payments;
computing the cost of purchase of a payment method's native currency, subtracting the sum of rewards for a payment method, adding the sum of fees for a payment method;
marking the payment method as analyzed and removing it from the list of unanalyzed payment methods;
repeating the computing for each payment method until the list of unanalyzed payment methods is empty;
ranking the payment methods from lowest cost to highest cost; and
selecting a payment ranked first, considering user preferences if one more payment methods are ranked first.

12. The method of claim 11 wherein the sum of rewards is computed as a function of the information used to configure the server and the information about the purchase.

13. The method of claim 12 wherein the sum of fees is computed as a function of the information used to configure the server and the information about the purchase.

14. The method of claim 13 wherein the computing the cost of the purchase in the payment method's native currency comprises the use of location information provided by the global positioning system to determine what currency is used in the locale of the merchant.

15. The method of claim 14 wherein the sum of rewards includes promotional and instant rewards.

16. The method of claim 14 wherein the sum of rewards includes computing a value of the interest earned from an interest bearing account between the time of purchase and the time of bill payment for a payment method if the payment method allows interest free payments.

17. The method of claim 14 wherein the sum of rewards includes rewards obtained from tier-based rewards by:
considering purchaser information comprising past spending habits, predicted spending habits and input as to how these spending habits may be modified;
calculating a probability that a user will reach a tier in a tier-based reward structure;
computing an instant reward on the purchase from the tier-based reward system;
computing future potential rewards from the tier-based reward system.

18. The method of claim 17 wherein the computing of future potential rewards comprises
computing a future probable amount to be spent in a reward tier using a payment method associated with the tier-based reward system using past spending habits, predicted spending habits and input as to how these spending habits may be modified and
computing the probable additional reward amount earned in the tier-based reward system resulting from the probable amount to be spent.
